(19) United States
(12) Patent Application Publication
(10) Pub. No.: US 2003/0221795 A1
(43) Pub. Date: Dec. 4, 2003

(54) VARIED FABRIC BLIND DRAPERY

(75) Inventor: Pey-Son Hsu, Changhua Hsien (TW)

Correspondence Address: BACON & THOMAS, PLLC, 625 SLATERS LANE, FOURTH FLOOR, ALEXANDRIA, VA, 22314

(73) Assignee: Ching Feng Blinds Ind. Co., Ltd., Changhua Hsien (TW)

(21) Appl. No.: 10/121,686

(22) Filed: Apr. 15, 2002

(51) Int. Cl. E06B 3/48

(52) U.S. Cl. 160/84.01

(57) ABSTRACT

A varied fabric blind drapery is made up of an upper beam, a fabric drapery fastened to the underside of said upper beam, and two cord fixing seats disposed at both sides of said upper beam respectively wherein one cord fixing seat is provided with a pull cord while the other with two pull cords. The fabric drapery, a rectangular body of proper width, has a plurality of cord passing holes integrally woven by the weft and warp yarns thereof for the pull cord disposed at one cord fixing seat thereof to be led through one by one at the central line thereof and the two pull cords at the other cord fixing seat to be led from both left and right sides thereof, each extending downwards to be tied up into a fixing knot at the bottom thereof; whereby, either the one pull cord or the two pull cords thereof can be drawn respectively to lead up the fixing knots thereof, thus easily and quickly change the drapery display for variation. Moreover, the number of said pull cords thereof can be added up to, for example, two for each cord fixing seat to permit a variety of drapery display for variation. Or linking ropes fastened to both lateral sides of said fabric drapery by knots and tied up to said pull cord by linking joints are provided to produce wave-like folds displayed at both lateral sides of said fabric drapery for more variations.

### BACKGROUND OF THE INVENTION

The present invention is related to a varied fabric blind drapery, having an upper beam, a fabric drapery fastened to the underside of said upper beam, and two cord fixing seats disposed at both sides of said upper beam respectively wherein one cord fixing seat is provided with a pull cord while the other with two pull cords. The fabric drapery, a rectangular body of proper width, has a plurality of cord passing holes integrally woven by the weft and warp yams thereof for the pull cords to be led through and tied up into knots at the bottom thereof; whereby, the pull cords can be drawn to lead up the fixing knots thereof, thus easily and quickly change the drapery display for variation. Moreover, the number of the pull cords can be added to permit a variety of drapery display for variation. Or linking ropes attached to said pull cord with linking joints are provided to produce a wave-like pattern at both lateral sides of said fabric drapery for more variation.

Please refer to FIG. 1 showing a conventional fabric blind drapery in operation. A conventional fabric blind drapery is made up of an upper beam 11 and a pull cord 12 disposed at one side of said upper beam 11 wherein said pull cord 12 is provided with a plurality of adjustable linking hooks 13, each having a fixing ring 15 disposed below at one end to be attached with a fabric drapery body 14 divided into two pieces. Said pull cord 12 is applied to control the open or close movement of said fabric drapery body 14 thereof via said linking hooks 13 with said fixing rings 15.

There are several drawbacks to such conventional fabric blind drapery. First, it is monotonous in the drapery display since the fabric drapery body 14 moves only crosswise from left to right with simple irregular folds displayed in the front thereof. Second, it is quite inconvenient since the fixing rings 15 attached to the fabric drapery body 14 and the linking hooks 13 disposed at the pull cord 12 might easily come off when the force of drawing said pull cord 12 is not evenly applied.

### SUMMARY OF THE PRESENT INVENTNION

It is, therefore, the primary purpose of the present invention to provide a varied fabric blind drapery, comprising an upper beam, a fabric drapery attached to the underside of said upper beam, two cord fixings seat disposed at both sides of said upper beam respectively, and pull cords disposed at both cord fixing seats thereof wherein said pull cords are extended to be tied up into fixing knots at the bottom of said fabric drapery; whereby said pull cords can be drawn to lead up said fixing knots thereof, raising said fabric drapery vertically with wave-like folds displayed at the bottom edge of said fabric drapery for variation.

It is, therefore, the second purpose of the present invention to provide a varied fabric blind drapery wherein said fabric drapery is provided with a plurality of cord passing holes integrally woven by the weft and warp yarns thereof for said pull cords to be led through directly and securely without the shortage of coming off easily.

It is, therefore, the third purpose of the present invention to provide a varied fabric blind drapery wherein said pull cords, when force of pulling is applied, will lead up the fixing knots thereof evenly which have said fabric drapery steadily folded up into beautiful drapery display.

### BRIEF DESCRIPTION OF THE DRAWINGS

FIG. 1 is a diagram showing the conventional fabric blind drapery in operation.

FIG. 2 is a perspective view of the present invention.

FIG. 3 is a sectional view of the present invention in operation.

FIG. 4 is a diagram showing another embodiment of the present invention.

FIG. 5 is a diagram showing a third embodiment of the present invention.

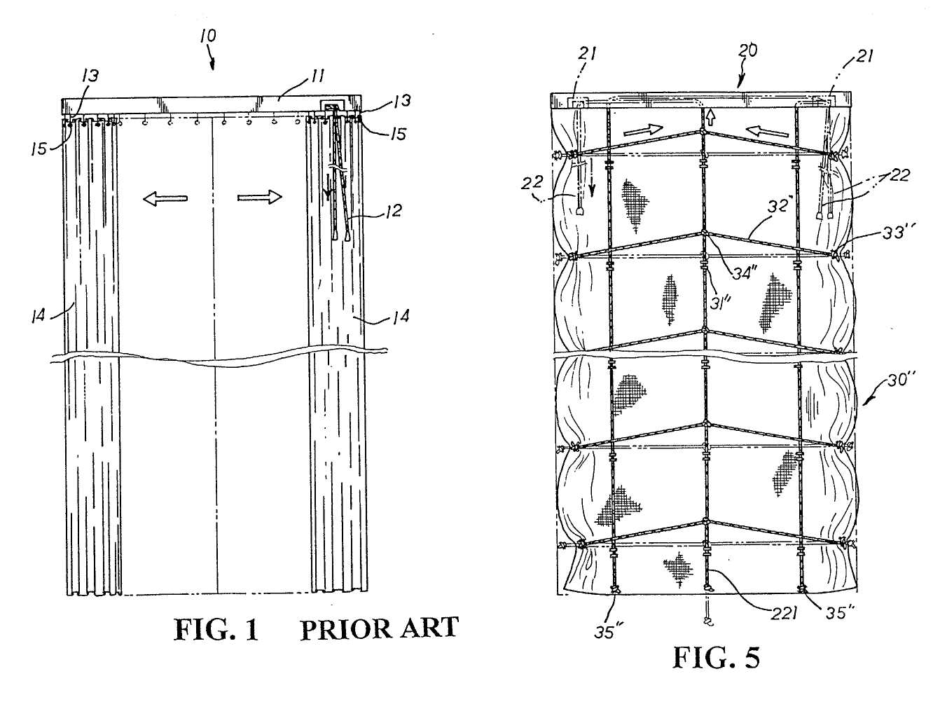

### DETAILED DESCRIPTION OF THE PREFERRED EMBODIMENTS

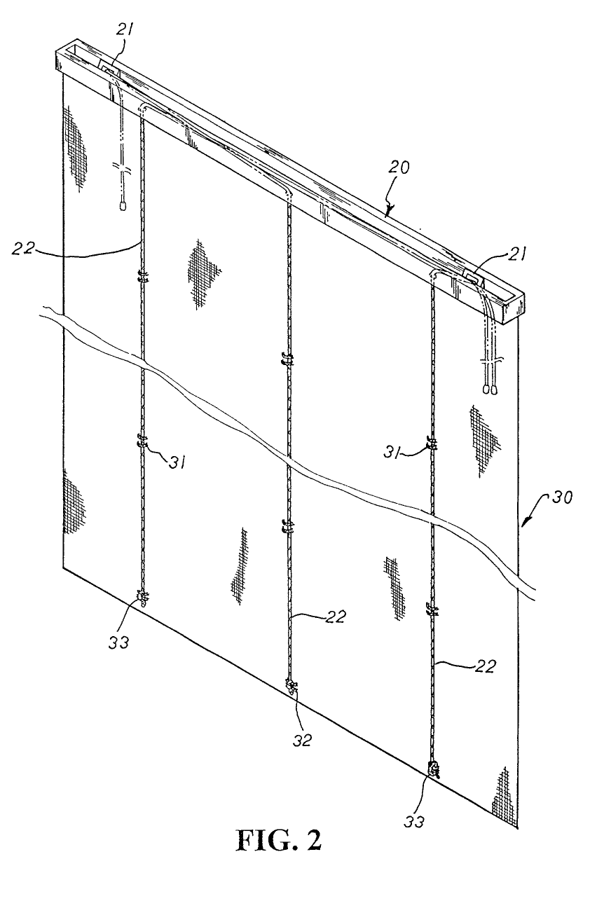

Please refer to FIG. 2 showing a perspective view of the present invention. The present invention is related to a varied fabric blind drapery, comprising an upper beam 20, a fabric drapery 30 fastened to the underside of said upper beam 20, and two cord fixing seats 21 disposed at both sides of said upper beam 20 respectively. One cord fixing seat 21 disposed at one side of the upper beam 20 thereof is provided with a pull cord 22, while the other cord fixing seat 21 disposed at the other side thereof is provided with two pull cords 22. Said fabric drapery 30 is a rectangular piece of proper width, having a plurality of cord passing holes 31 integrally woven by the weft and warp yards and distributed on the surface of said fabric drapery 30 thereof. In assembly, the pull cord 22 disposed at one cord fixing seat 21 thereof is led through the cord passing holes 31 disposed at the central line of said fabric drapery 30 one by one, extending downwards from the top to the bottom thereof to be tied up into a fixing knot 32. In similar manner, the other two pull cords 22 disposed at the other side of said upper beam 20 thereof are led through said cord passing holes 31 disposed at both left and right sides of said fabric drapery 30, each extending from either left or right side thereof downwards to be tied up into a fixing knot 32.

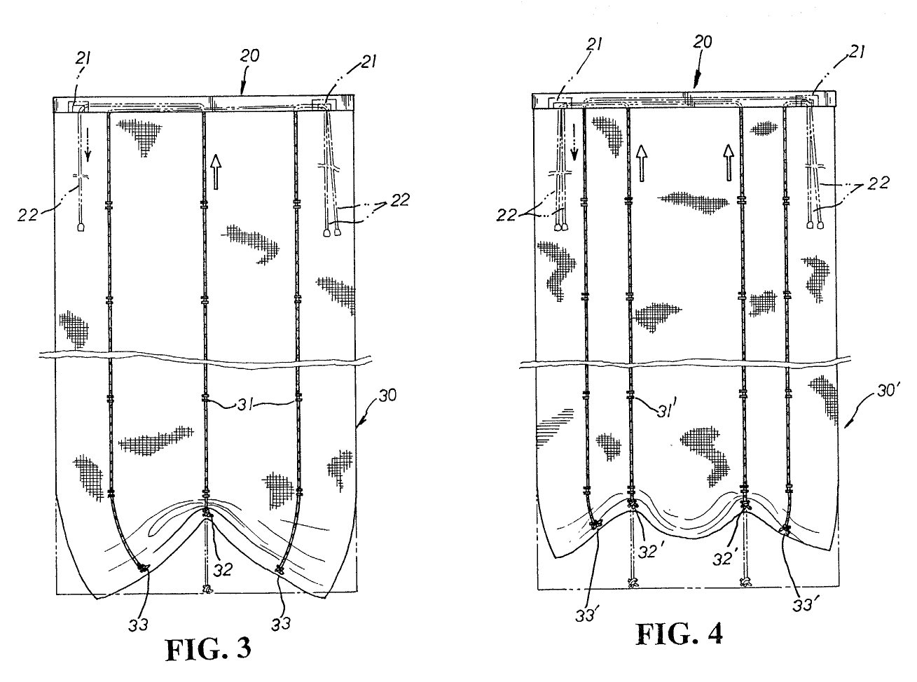

Please refer to FIG. 3 showing a sectional view of the present invention. In operation, the pull cord 22 disposed at one side of the upper beam 20 thereof is drawn to lead up the fixing knot 32 disposed at the central bottom of said fabric drapery 30 and thus raise said fabric drapery 30 by a central line thereof, forming a drapery display wherein the central line thereof is higher than both left and right sides of the fabric drapery 30 thereof as shown in FIG. 3. Alternatively, the two pulling cords disposed at the other side of said upper beam 20 thereof can be drawn to lead up the fixing knots 33 disposed at the left-and-right side bottom of the fabric drapery 30, raising the said fabric drapery 30 at both sides to vary the drapery display as shown in FIG. 3.

Please refer to FIG. 4 showing another embodiment of the present invention. The underside of said upper beam 20 is engaged with another fabric drapery 30′ and a cord fixing seat 21 is disposed at each side of the upper beam 20 thereof wherein each cord fixing seat 21 is provided with two pull cords 22. In assembly, the two pull cords 22 thereof disposed at one cord fixing seat 21 are led through the cord passing holes 31′ disposed at the middle section of the fabric drapery 30′, each extending downwards to be tied up into a fixing knot 32′ at the bottom thereof, while the two pull cord 22 disposed at the other cord fixing seat 21 are led through the cord passing holes 31′ disposed at both left and right sides of the fabric drapery 30′ thereof, each extending downwards to be tied up into a fixing knot 32′ at the bottom thereof.

In operation, the two pull cords 22, led through the cord passing holes 31′ disposed at the middle of the fabric drapery 30′ thereof, are drawn, leading up the two fixing knots 32′ disposed at the middle bottom of the fabric drapery 30′ thereof to form wave-like folds in the drapery display as shown in FIG. 4.

Please refer to FIG. 5 showing a third embodiment of the present invention. The underside of the upper beam 20 is engaged with the fabric drapery 30″ and each side of the upper beam 20 is provided with a cord fixing seat 21 wherein one fixing seat 21 thereof is provided with a pull cord 22 and the other fixing seat 21 thereof is provided with two pull cords 22. In assembly, a plurality of linking ropes 32″ equidistantly and horizontally disposed at the cord passing holes 31″ thereof are fastened to both lateral sides of said fabric drapery 30″ by knots 33″. The pull cord 22 disposed at one side of the upper beam 20 is led through the cord passing holes 31″ disposed at the central line of said fabric drapery 30 one by one, tying up with each of said linking ropes 32″ to form a linking joint 34″ when extending downwards to leave an extra flexible pull cord section 221 disposed lower than the bottom of said fabric drapery 30″. The two pull cords 22 disposed at the other side of said upper beam 20 are led through the cord passing holes 31 disposed at both left and right sides of the fabric drapery 30″, each extending downwards to tie up into a fixing knot 35″ at the bottom thereof.

In operation, the pull cord 22 disposed at one side of said upper beam 20 is drawn, leading upwards the flexible pull cord section 221 thereof and the linking joints 34″ engaging said linking ropes 32″ with said pull cord 22 led through said cord passing holes 31 disposed at the central line of said fabric drapery 30″. Meanwhile, the linking joints 34″ thereof raised upward by said drawn pull cord 22 will bring in the knots 33″ disposed at both lateral sides of the fabric drapery 30″, gathering in the both lateral sides of said fabric drapery 30″ thereof to produce wavelike folds in the drapery display as shown in FIG. 5.

What is claimed is:

1. A varied fabric blind drapery, comprising an upper beam, a fabric drapery fastened to the underside of said upper beam, and two cord fixing seats disposed at both sides of said upper beam respectively wherein one cord fixing seat thereof is provided with a pull cord while the other cord fixing seat with two pull cords; said varied fabric blind drapery characterized by that:
said fabric drapery, a rectangular body of proper width, has a plurality of cord passing holes integrally woven by the weft and warp yarns of said fabric drapery;
in assembly, said pull cord disposed at one cord fixing seat thereof being led through said cord passing holes disposed at the central line of said fabric drapery one by one, extending downwards to be tied up into a fixing knot at the bottom, while the other pull cords disposed at the other cord fixing seat thereof being led through said cord passing holes disposed at both left and right sides of said fabric drapery, extending downwards to be tied up into fixing knots;
whereby, either the one pull cord or the two pull cords thereof can be drawn to lead up the fixing knot disposed at the central bottom thereof or the fixing knots disposed at both left and right side bottom thereof, thus easily and quickly change the drapery display for variation.

2. The varied fabric blind drapery as claimed in claim 1 wherein the number of said pull cords disposed at said cord fixing seats thereof can be added up to, for example, two for each cord fixing seat to permit a variety of drapery display for variation.

3. The varied fabric blind drapery as claimed in claim 1 wherein a plurality of linking ropes, equidistantly and horizontally disposed at said cord passing holes thereof, are fastened to both lateral sides of said fabric drapery by knots and tied up into linking joints with said pull cord which are led through the cord passing holes disposed at the central line of said fabric drapery to extend downwards, leaving an extra flexible pull cord section disposed lower than the bottom thereof, whereby, the drawn pull cord will raise upwards said flexible pull cord section and thus said linking joints of said linking ropes thereof, bringing in the knots disposed at both lateral sides of said fabric drapery to form wave-like folds displayed at both lateral sides thereof for variation.
